(19) United States
(12) Patent Application Publication
(10) Pub. No.: US 2016/0009536 A1
(43) Pub. Date: Jan. 14, 2016

(54) WATER DISPENSER

(71) Applicant: KABUSHIKI KAISHA COSMO LIFE, Kakogawa-shi, Hyogo (JP)

(72) Inventor: Yoshinori ORITA, Hyogo (JP)

(21) Appl. No.: 14/772,109

(22) PCT Filed: Dec. 12, 2013
(86) PCT No.: PCT/JP2013/083330

§ 371 Date: Sep. 2, 2015

(30) Foreign Application Priority Data
Mar. 5, 2013 (JP) 2013-042947

(51) Int. Cl. B67D 1/00; B67D 1/08

(52) U.S. Cl. CPC B67D 1/0004; B67D 1/0804; B67D 1/0857; B67D 1/0895

(57) ABSTRACT

A water dispenser includes a replaceable water bottle formed flexible so as to be collapsible as the amount of water remaining in the water bottle decreases. The water dispenser further includes a raw water pumping pipe provided with: a water inlet hole configured such that drinking water in the water bottle can be introduced into the raw water pumping pipe through the water inlet hole, when the raw water pumping pipe is connected to the water bottle; and an air inlet hole configured such that air in the water bottle can be introduced into the drinking water in the raw water pumping pipe through the air inlet hole, as air bubbles, when the water level in the water bottle is higher than the position of the water inlet hole.

### TECHNICAL FIELD

The present invention relates to a water dispenser which supplies drinking water from a replaceable water bottle filled with drinking water such as mineral water.

### BACKGROUND ART

Conventionally, water dispensers have been used primarily in offices and in hospitals. With a growing interest in water safety and health in recent years, however, water dispensers are gaining popularity among ordinary households. A well-known type of water dispenser are ones in which a replaceable water bottle is set on the upper surface of a housing, and drinking water filled in the water bottle is allowed to fall into a cold water tank housed inside the housing by gravity, as disclosed in the below-identified Patent Document 1.

In the above mentioned water dispensers, the water bottle includes a hollow cylindrical trunk portion, a bottom portion provided at one end of the trunk portion; and a neck portion provided at the other end of the trunk portion through a shoulder portion; wherein a water outlet port is provided at the distal end of the neck portion. This water bottle is set in the water dispenser with the water outlet port at the distal end of the neck portion facing downward. The trunk portion of the water bottle is formed flexible so as to be collapsible as the amount of water remaining in the water bottle decreases.

Since, in the water dispenser disclosed in Patent Document 1, the water bottle is set on the upper surface of the housing, a fully filled water bottle needs to be lifted high when replacing the water bottle. However, the fully filled water bottle usually contains drinking water of about 10 to 12 liters, weighing 10 kg or more. Therefore, replacement of the water bottle was a tough task for water dispenser users (for women and the elderly in particular).

In view of this, the inventor of the present invention has investigated for a water dispenser in which the water bottle is set at the lowest possible position in the water dispenser, in order to allow for an easy replacement of the water bottle. If the water bottle is placed at a lower position, there is no need to lift up the fully filled water bottle having a considerable weight when setting it to the water dispenser, and the replacement of the water bottle can be performed with ease.

On the other hand, if the water bottle is set to the lower portion of the water dispenser, the position of the water bottle becomes lower relative to that of the cold water tank disposed inside the water dispenser, and thus, it is not possible to utilize a mechanism to let drinking water filled in the water bottle fall into the cold water tank disposed inside the water dispenser by gravity. Accordingly, a pump for pumping out drinking water from the water bottle is required so that drinking water can be supplied from the water bottle to the cold water tank.

### PRIOR ART DOCUMENTS

### Patent Documents

Patent Document 1: JP 2008-273605 A

### SUMMARY OF THE INVENTION

### Problems to be Solved by the Invention

The present inventor has focused on the fact that, if the water bottle formed flexible so as to be collapsible as the amount of water remaining in the water bottle decreases is used, and the pump for pumping up drinking water from the water bottle is provided in the water dispenser, it is not necessary to dispose the water outlet port of the water bottle facing downward, as in the water dispensers which utilize a mechanism to let drinking water fall by gravity. Based on the above mentioned perspective, the present inventor has arrived at an idea to dispose the water bottle in a position lying on its side (in other words, with the water outlet port of the water bottle directed horizontally), when setting it to the water dispenser.

The arrangement to set the water bottle with the water outlet port of the water bottle directed horizontally allows for more freedom in the design of the water dispenser. For example, a configuration is possible in which the water bottle is horizontally slidably supported with the water outlet port of the water bottle directed horizontally, and the raw water pumping pipe is fixed inside the water dispenser such that the sliding operation of the water bottle permits the water outlet port of the water bottle to be connected to and disconnected from the raw water pumping pipe. With this arrangement, the length of the raw water pumping pipe can be made short, thereby preventing the proliferation of bacteria in the raw water pumping pipe.

However, when the present inventor has actually carried out numbers of experiments to pump out drinking water W in a water bottle 90 by a pump 91, with the water bottle 90 in a position lying on its side as shown in FIG. 14, he has found out that there are cases where drinking water W cannot be pumped out any further with a large amount of drinking water W still remaining in the water bottle 90. This problem will be described in detail below.

As shown in FIG. 15, when the water level in the water bottle 90 (i.e., the boundary between air A and the drinking water W) is higher than the position of a water inlet hole 93 provided at an end portion 92a of a raw water pumping pipe 92, the raw water pumping pipe 92 and the pump 91 are filled with drinking water W. Therefore, drinking water W in the water bottle 90 is pumped out through the raw water pumping pipe 92, due to the suction force of the pump 91 shown in FIG. 14.

However, when, thereafter, the water level in the water bottle 90 falls to the position of the water inlet hole 93 provided at the end portion 92a of the raw water pumping pipe 92 as shown in FIG. 16, air A in the water bottle 90 enters the pump 91 through the raw water pumping pipe 92. This causes the pump 91 to idle and to lose its suction force, and it becomes difficult to pump out drinking water W in the water bottle 90 any further. At this time, a maximum of about 1 to 2 liters of the drinking water W could remain in the water bottle 90, as drinking water W which is difficult to be pumped up by the pump 91 (see FIG. 14).

Accordingly, an object of the present invention is to provide a water dispenser including a replaceable water bottle formed flexible so as to be collapsible as the amount of water remaining in the water bottle decreases, wherein the amount of drinking water remaining in the water bottle can be reduced when the drinking water is pumped out from the water bottle.

### Means for Solving the Problems

In order to solve the above mentioned problems, the present invention has adapted the following constitution.

A water dispenser comprising: a raw water pumping pipe configured to be connected to a replaceable water bottle formed flexible so as to be collapsible as the amount of water remaining in the water bottle decreases; and a pump for pumping out drinking water from the water bottle through the raw water pumping pipe;

wherein the raw water pumping pipe includes:

a water inlet hole arranged such that with the raw water pumping pipe connected to the water bottle, drinking water in the water bottle can be introduced into the raw water pumping pipe through the water inlet hole; and

an air inlet hole arranged such that air in the water bottle can be introduced into the drinking water in the raw water pumping pipe through the air inlet hole, as air bubbles, when the water level in the water bottle is higher than the position of the water inlet hole.

With this arrangement, when the water level in the water bottle has fallen to the position of the air inlet hole, and drinking water in the water bottle is further pumped out by the pump in this state, air inside the water bottle is introduced into the raw water pumping pipe through the air inlet hole. At this time, although air introduced into the raw water pumping pipe enters the pump, it does not cause the pump to lose its suction force, because this air is mixed into the drinking water as air bubbles. Air in the water bottle is decreased by the amount equal to the amount of air discharged from the water bottle as air bubbles. This allows for increasing the extent to which the water bottle collapses when the water level in the water bottle falls to the position of the water inlet hole, thereby reducing the amount of drinking water remaining in the water bottle.

It is preferred that the air inlet hole be formed to have a sectional area that is smaller than the sectional area of the water inlet hole. With this arrangement, the air introduced into the raw water pumping pipe through the air inlet hole can be turned into air bubbles, even if a pump capable of discharging only a small amount of water is used, and contributes to the reduction in the cost.

### Effect of the Invention

In the water dispenser according to the present invention, when the water level in the water bottle has fallen to the position of the air inlet hole, and the drinking water in the water bottle is further pumped out by the pump in this state, air in the water bottle is discharged as air bubbles along with drinking water. This allows for increasing the extent to which the water bottle collapses when the water level in the water bottle falls to the position of the water inlet hole, thereby reducing the amount of drinking water remaining in the water bottle.

### BRIEF DESCRIPTION OF THE DRAWINGS

FIG. 1 is a sectional view of a water dispenser embodying the present invention, as seen from the side of the water dispenser.

FIG. 2 is an enlarged sectional view of the water dispenser shown in FIG. 1, showing the vicinity of a bottle holder.

FIG. 3 is a sectional view, taken along the line III-III in FIG. 2.

FIG. 4 is a sectional view illustrating the state in which the bottle holder shown in FIG. 2 has been pulled out of a housing.

FIG. 5 is an enlarged sectional view of the water dispenser shown in FIG. 2, showing the vicinity of a joint portion of a raw water pumping pipe.

FIG. 6 is an enlarged sectional view of the water dispenser shown in FIG. 5, showing the vicinity of the distal end of the joint portion.

FIG. 7 is an enlarged sectional view illustrating the process in which the joint portion shown in FIG. 5 is connected to a water outlet port of a water bottle.

FIG. 8 is an enlarged sectional view illustrating the state in which the joint portion shown in FIG. 7 has been brought into contact with a plug attached to the water outlet port of the water bottle.

FIG. 9 is an enlarged sectional view illustrating the state in which drinking water in the water bottle shown in FIG. 2 has been pumped out by a pump, and the water level in the water bottle has fallen to the position of a water inlet hole of the raw water pumping pipe.

FIG. 10 is an enlarged sectional view showing the vicinity of the joint portion shown in FIG. 2, illustrating the process in which drinking water in the water bottle flows into the joint portion through both an air inlet hole and the water inlet hole, when the pump is actuated with the water level in the water bottle being higher than the position of the air inlet hole.

FIG. 11 is an enlarged sectional view showing the vicinity of the joint portion shown in FIG. 2, illustrating the process in which air in the water bottle flows into the joint portion through the air inlet hole as air bubbles, when the pump is actuated with the water level in the water bottle being lower than the position of the air inlet hole and higher than the position of the water inlet hole.

FIG. 12 is an enlarged sectional view showing the vicinity of the joint portion, illustrating the case in which the air inlet hole is formed to have a sectional area larger than that of the air inlet hole shown in FIG. 11, and in which the pump having a smaller size is used.

FIG. 13 is a sectional view of the water dispenser shown in FIG. 1, when it is in a sterilization operation mode.

FIG. 14 is a sectional view of a water dispenser in which no air inlet hole is formed in a joint portion of a raw water pumping pipe, illustrating the state where a large amount of drinking water is remaining in a water bottle when the drinking water in the water bottle has been pumped out.

FIG. 15 is an enlarged sectional view showing the vicinity of the joint portion shown in FIG. 14, illustrating the process in which drinking water in the water bottle flows into the joint portion through a water inlet hole, when the pump is actuated with the water level in the water bottle being higher than the position of the water inlet hole.

FIG. 16 is an enlarged sectional view showing the vicinity of the joint portion shown in FIG. 14, illustrating the state where the water level in the water bottle has fallen below the position of the water inlet hole.

### MODE FOR CARRYING OUT THE INVENTION

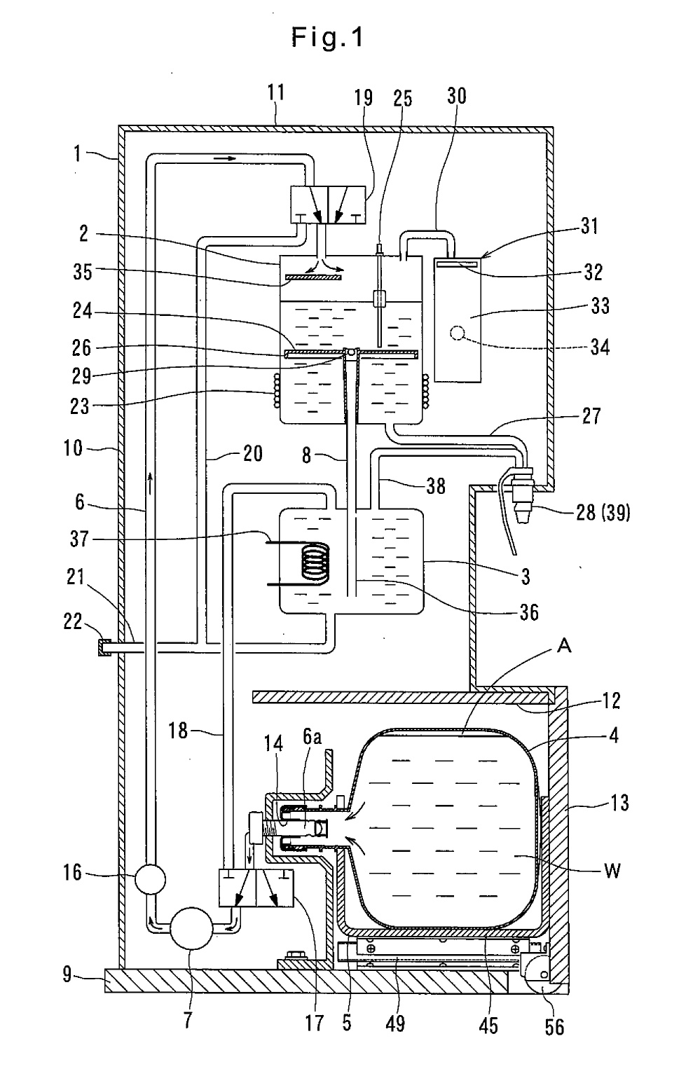

A water dispenser embodying the present invention is shown in FIG. 1. This water dispenser includes: a vertically elongated housing 1; a cold water tank 2 and a hot water tank 3 both housed in the upper portion of the housing 1; a replaceable water bottle 4 housed in the lower portion of the housing 1; a bottle holder 5 for supporting the water bottle 4; a raw water pumping pipe 6 which allows communication between the water bottle 4 and the cold water tank 2; a pump 7 provided in the raw water pumping pipe 6; and a tank connecting passage 8 connecting the cold water tank 2 to the hot water tank 3. The cold water tank 2 and the hot water tank 3 are arranged vertically such that the hot water tank 3 is positioned below the cold water tank 2.

The housing 1 includes a bottom plate 9, a peripheral wall 10 rising from the periphery of the bottom plate 9, and a top plate 11 provided at the top end of the peripheral wall 10. The peripheral wall 10 has, at the lower portion of its front side, a loading space 12 into and out of which the water bottle 4 can be moved, and a front door 13 for opening and closing the loading space 12.

The end portion of the raw water pumping pipe 6 on the up-stream side is provided with a joint portion 6a configured to be detachably connected to a water outlet port 14 of the water bottle 4, and the end portion of the raw water pumping pipe 6 on the down-stream side is connected to the cold water tank 2. The raw water pumping pipe 6 extends downward from the joint portion 6a and is then redirected upward so that it passes through a position lower than the joint portion 6a. The pump 7 is provided in the raw water pumping pipe 6 at its portion lower than the joint portion 6a.

The pump 7 transfers the drinking water in the raw water pumping pipe 6 from the side of the water bottle 4 toward the cold water tank 2, thereby pumping out drinking water from the water bottle 4 through the raw water pumping pipe 6. A diaphragm pump can be used as the pump 7. While not shown, the diaphragm pump includes a diaphragm which reciprocates; a pump chamber whose volume is increased and decreased by the reciprocation of the diaphragm, and including a suction port and a discharge port; a suction side check valve provided at the suction port and configured to allow only the flow of water into the pump chamber; and a discharge side check valve provided at the discharge port and configured to allow only the flow of water out of the pump chamber. The diaphragm pump sucks in drinking water through the suction port when the volume of the pump chamber is increasing due to the movement of the diaphragm in one direction, and discharges drinking water through the discharge port when the volume of the pump chamber is decreasing due to the movement of the diaphragm in the other direction.

Further, a gear pump can also be used as the pump 7. While not shown, the gear pump includes a casing; a pair of gears meshing with each other and housed inside the casing; and a suction chamber and a discharge chamber defined by the meshing portions of the pair of gears in the casing. The gear pump transfers drinking water trapped between the tooth spaces of the pair of gears and the inner surface of the casing of the gear pump from the side of the suction chamber toward the discharge chamber, by the rotation of the gears.

Alternatively, the pump 7 may be a centrifugal pump. While not shown, the centrifugal pump includes a centrifugal impeller which is driven for rotation, a casing in which the centrifugal impeller is housed, a suction port provided in the center of the casing, and a discharge port provided at the outer peripheral portion of the casing. The centrifugal pump transfers drinking water from the side of the suction port toward the discharge port by a centrifugal force provided by the rotation of the centrifugal impeller.

A flow rate sensor 16 is provided in the raw water pumping pipe 6 on the discharge side of the pump 7. When there is no drinking water flowing in the raw water pumping pipe 6 while the pump 7 is in operation, the flow rate sensor 16 is capable of detecting this fact.

A first switching valve 17 is provided in the raw water pumping pipe 6 at its portion between the joint portion 6a and the pump 7. Although the first switching valve 17 is placed at a position away from the joint portion 6a in the figures, the first switching valve 17 may be directly connected to the joint portion 6a. A first bypass pipe 18 is connected to the first switching valve 17 and communicates with the hot water tank 3. The end portion of the first bypass pipe 18 on the side of the hot water tank 3 is connected to the upper surface of the hot water tank 3.

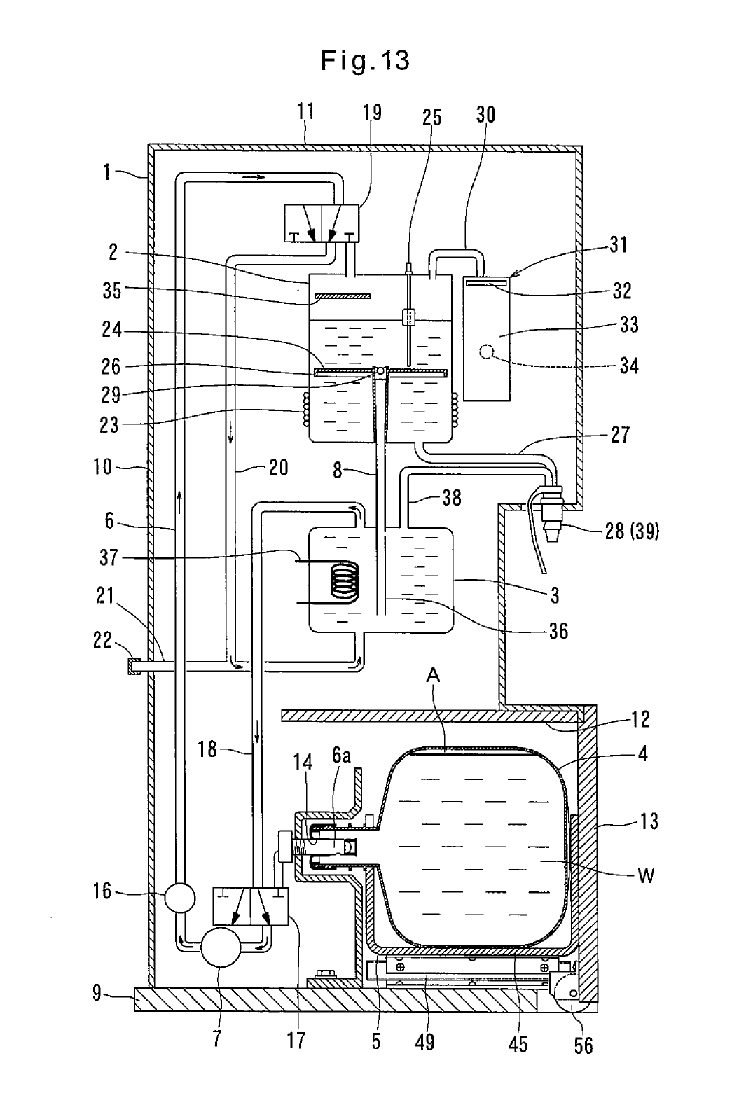

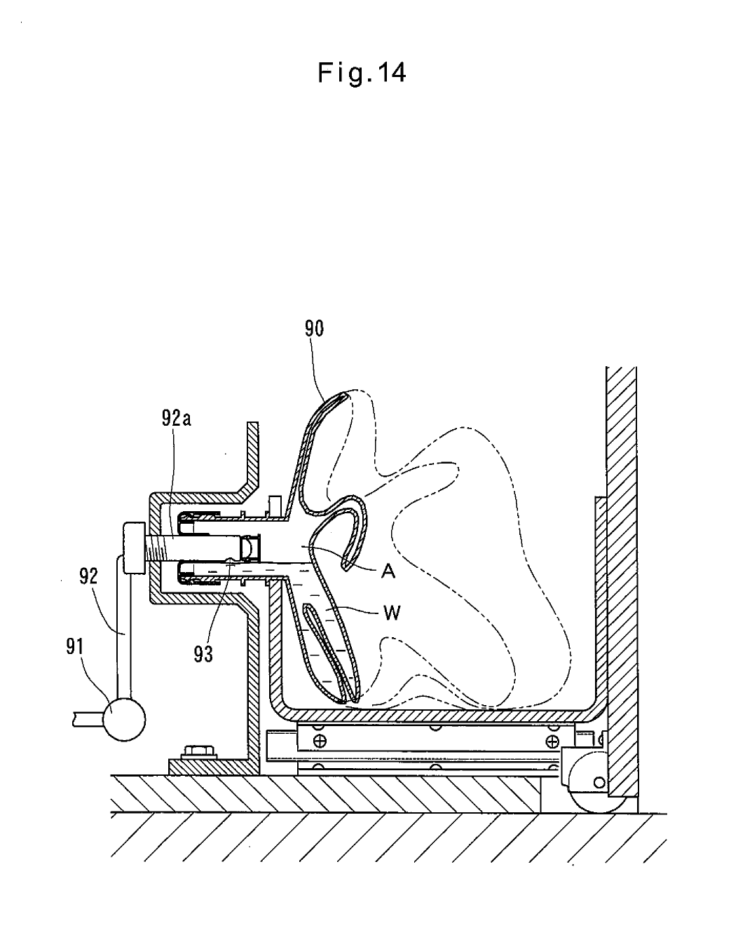

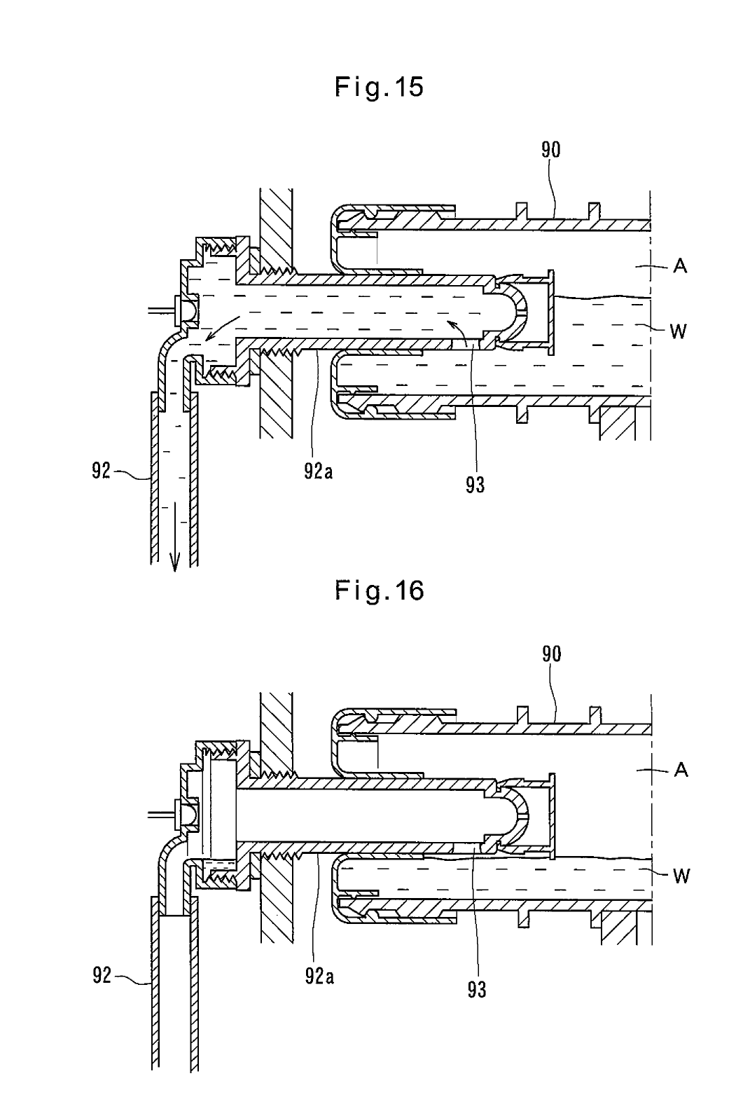

The first switching valve 17 is configured to be capable of switching the flow path between a normal operation mode (see FIG. 1) and a sterilization operation mode (see FIG. 13). In the normal operation mode, the first switching valve 17 allows communication between the joint portion 6a and the pump 7, while blocking communication between the first bypass pipe 18 and the pump 7; and in the sterilization operation mode, the first switching valve 17 blocks communication between the joint portion 6a and the pump 7, and allows communication between the first bypass pipe 18 and the pump 7.

A second switching valve 19 is provided at the end portion of the raw water pumping pipe 6 on the side of the cold water tank 2, and it can be switched to carry out sterilization by hot water. A second bypass pipe 20 is connected to the second switching valve 19 and communicates with the hot water tank 3. The end portion of the second bypass pipe 20 on the side of the hot water tank 3 is connected to the bottom surface of the hot water tank 3. Further, a drain pipe 21 is connected to the second bypass pipe 20 and extends to the exterior of the housing 1. The outlet of the drain pipe 21 is closed with a plug 22. However, an on-off valve may be provided instead of the plug 22.

The second switching valve 19 is configured to be capable of switching the flow path between a normal operation mode (see FIG. 1) and a sterilization operation mode (see FIG. 13). In the normal operation mode, the second switching valve 19 allows communication between the raw water pumping pipe 6 and the cold water tank 2, while blocking communication between the raw water pumping pipe 6 and the second bypass pipe 20; and in the sterilization operation mode, the second switching valve 19 blocks communication between the raw water pumping pipe 6 and the cold water tank 2, and allows communication between the raw water pumping pipe 6 and the second bypass pipe 20.

Although each of the first switching valve 17 and the second switching valve 19 is illustrated as a single, three-way valve in the figures, a three-way valve assembly comprising a plurality of on-off valves may be used to achieve the same effect.

The cold water tank 2 contains air and drinking water in upper and lower layers. A cooling device 23 is attached to the cold water tank 2, and is configured to cool the drinking water contained in the cold water tank 2. Further, a baffle plate 24 is provided inside the cold water tank 2 and partitions the interior of the cold water tank 2 into upper and lower sections. The cooling device 23 is disposed at the lower outer periphery of the cold water tank 2, so that the drinking water inside the cold water tank 2 below the baffle plate 24 is maintained at a low temperature (about 5 degrees Celsius).

A water level sensor 25 is installed in the cold water tank 2 and configured to detect the water level of the drinking water accumulated in the cold water tank 2. When the water level detected by the water level sensor 25 falls to a predetermined level, the pump 7 is actuated, and drinking water is supplied from the water bottle 4 to the cold water tank 2. The baffle plate 24 prevents the low temperature drinking water cooled by the cooling device 23 and accumulated in the lower portion of the cold water tank 2 from being stirred by the normal temperature drinking water supplied from the water bottle 4 into the cold water tank 2, when the latter is supplied from the water bottle 4 to the cold water tank 2. The baffle plate 24 has a cylindrical suspended wall 26 extending downward from the outer peripheral edge of the baffle plate 24. By holding air in the space surrounded by the suspended wall 26, the insulation effect between the portions above and beneath the baffle plate 24 improves.

A cold water discharge passage 27 is connected to the bottom surface of the cold water tank 2 such that the low temperature drinking water accumulated in the lower portion of the cold water tank 2 can be discharged to the outside through the cold water discharge passage 27. The cold water discharge passage 27 is provided with a cold water cock 28 capable of being operated from outside the housing 1, so that low temperature drinking water can be discharged from the cold water tank 2 into a cup or the like by opening the cold water cock 28. The capacity of the cold water tank 2 is lower than that of the water bottle 4, and is about from 2 to 4 liters.

A tank connecting passage 8 connecting the cold water tank 2 and the hot water tank 3 has a top end opening at the center of the baffle plate 24. A check valve 29 is provided at the end portion of the tank connecting passage 8 on the side of the cold water tank 2. The check valve 29 permits the flow of drinking water from the side of the cold water tank 2 toward the hot water tank 3, and restricts the flow of drinking water from the side of the hot water tank 3 toward the cold water tank 2. The check valve 29 prevents the loss of energy in the cold water tank 2 and the hot water tank 3, by preventing the high temperature drinking water in the hot water tank 3 from flowing into the cold water tank 2 due to heat convection.

An air sterilization chamber 31 is connected to the cold water tank 2 through an air introduction passage 30. The air sterilization chamber 31 includes a hollow casing 33 in which an air inlet port 32 is formed, and an ozone generator 34 provided within the casing 33. The ozone generator 34 may be, for example, a low-pressure mercury lamp which irradiates ultraviolet light to the oxygen in the air to convert oxygen to ozone, or a silent discharge apparatus in which an AC voltage is applied between an opposed pair of electrodes covered with insulators to convert oxygen between the electrodes to ozone. The air sterilization chamber 31 is maintained in a state in which the casing 33 is filled with ozone at all times, by energizing the ozone generator 34 at regular intervals to generate ozone.

When the water level in the cold water tank 2 decreases, air is introduced into the cold water tank 2 through the air introduction passage 30 such that the pressure in the cold water tank 2 is maintained at atmospheric pressure. Since air introduced into the cold water tank 2 is sterilized with ozone by passing through the air sterilization chamber 31, the air inside the cold water tank 2 is maintained clean.

A diffuser plate 35 is provided in the cold water tank 2. The diffuser plate 35 is configured to diffuse the flow of drinking water transferred from the raw water pumping pipe 6 before it reaches the water surface of the drinking water accumulated in the cold water tank 2. The diffuser plate 35 increases the contact area between the drinking water and ozone contained in the air in the cold water tank 2 (i.e., ozone flowing into the cold water tank 2 through the air sterilization chamber 31), thereby improving the sanitation of the drinking water in the cold water tank 2.

The tank connecting passage 8 includes an in-tank pipe portion 36 extending downward from the upper surface of the hot water tank 3 through the interior of the hot water tank 3. The in-tank pipe portion 36 has an open lower end near the bottom surface of the hot water tank 3, thereby preventing high temperature drinking water accumulated in the upper portion of the hot water tank 3 from flowing into the in-tank pipe portion 36.

The hot water tank 3 is entirely filled with drinking water. A heating device 37 is mounted to the hot water tank 3, and is configured to heat the drinking water in the hot water tank 3 so that the drinking water in the hot water tank 3 is maintained at a high temperature (about 90 degrees Celsius). While an example in which a sheathed heater is used as the heating device 37 is shown in the figures, a band heater may be used instead. The sheathed heater is a heating device including a heating wire housed in a metal pipe and configured to generate heat when energized, and is installed to extend through the wall of the hot water tank 3 and into the interior of the hot water tank 3. A band heater is a cylindrical heat generator in which a heating wire which generates heat when energized is embedded, and would be attached around the outer periphery of the hot water tank 3 in close contact therewith.

A hot water discharge passage 38 is connected to the upper surface of the hot water tank 3 such that high temperature drinking water accumulated in the upper portion of the hot water tank 3 can be discharged to the outside through the hot water discharge passage 38. The hot water discharge passage 38 is provided with a hot water cock 39 capable of being operated from outside the housing 1, so that high temperature drinking water can be discharged from the hot water tank 3 into a cup or the like by opening the hot water cock 39. When drinking water is discharged from the hot water tank 3, the same amount of drinking water as the discharged drinking water flows into the hot water tank 3 from the cold water tank 2 through the tank connecting passage 8, so that the hot water tank 3 is maintained fully filled at all times. The capacity of the hot water tank 3 is about from 1 to 2 liters.

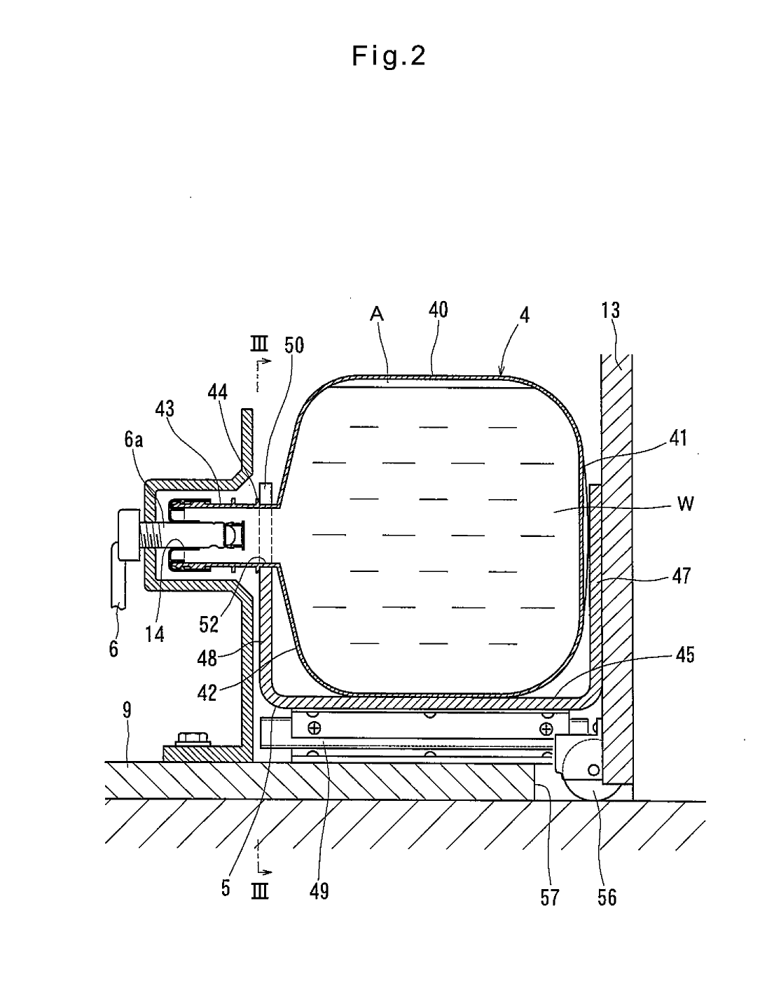

As shown in FIG. 2, the water bottle 4 includes a hollow cylindrical trunk portion 40, a bottom portion 41 provided at one end of the trunk portion 40, and a neck portion 43 provided at the other end of the trunk portion 40 through a shoulder portion 42, wherein the neck portion 43 is provided with a water outlet port. The diameter of the shoulder portion 42 is gradually decreased from the side of trunk portion 40 toward the neck portion 43. A flange 44 is formed on the outer periphery of the neck portion 43. The trunk portion 40 of the water bottle. 4 is formed flexible so as to be collapsible as the amount of water remaining in the water bottle 4 decreases. The water bottle 4 is formed by blow molding of a polyethylene terephthalate (PET) resin. The capacity of the water bottle 4 is from 10 to 20 liters when the bottle is fully filled. The water bottle 4 contains drinking water W, and air A which could not be eliminated when filling the water bottle 4 with the drinking water W.

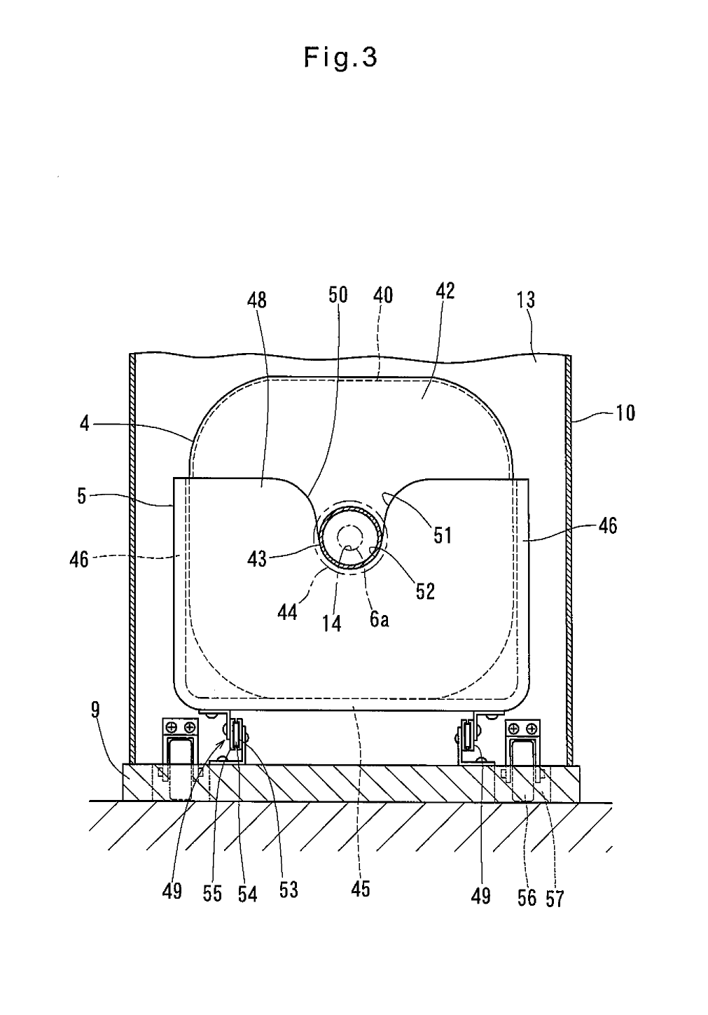

As shown in FIG. 2 and FIG. 3, the bottle holder 5 includes: a bottle mounting plate 45 configured to support the trunk portion 40 of the water bottle 4 from below with the water outlet port 14 of the water bottle 4 directed horizontally; side plates 46 positioned on both sides of the water bottle 4; a front plate 47 positioned forward of the water bottle 4; and a rear plate 48 positioned rearward of the water bottle 4. As used herein, the words “forward” and “rearward” refer, respectively, to the directions toward and away from a user standing in front of the water dispenser. The bottle holder 5 is supported by a right and left pair of slide rails 49 extending in the forward and rearward direction.

As shown in FIG. 3, the rear plate 48 of the bottle holder 5 is provided with a notch 50 opening to the upper edge of the rear plate 48. The notch 50 includes an introduction portion 51 narrowing gradually downwardly from the upper edge of the rear plate 48, and a semicircular restricting portion 52 formed contiguous to the lower side of the introduction portion 51, and configured to be fitted to the outer periphery of the neck portion 43 of the water bottle 4. The restricting portion 52 is fitted to the portion of the neck portion 43 closer to the trunk portion 40 than is the flange 44.

The restricting portion 52 is formed into a circular arc shape having a diameter smaller than the outer diameter of the flange 44 formed on the neck portion 43 of the water bottle 4. The restricting portion 52 is fitted to the outer periphery of the neck portion 43 to fix the position of the neck portion 43 in the radial direction, thereby preventing the position of the water outlet port 14 of the water bottle 4 from being displaced from the position of the joint portion 6a, when the water bottle 4 is connected to the joint portion 6a. Further, as shown in FIG. 2, the restricting portion 52 engages with the flange 44 of the neck portion 43 to fix the position of the neck portion 43 in the axial direction, thereby preventing the water outlet port 14 of the water bottle 4 from being disconnected from the joint portion 6a.

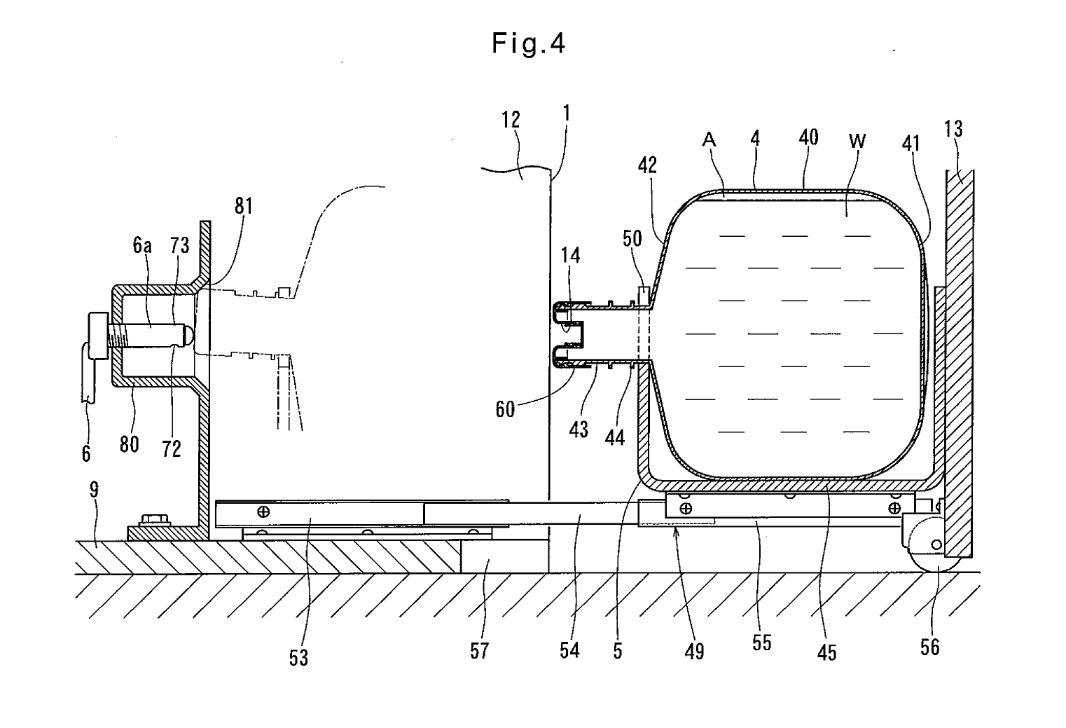

As shown in FIG. 4, each of the slide rails 49 includes a fixed rail member 53 fixed to the bottom plate 9 of the housing 1 and extending in the forward and rearward direction, an intermediate rail member 54 slidably supported by the fixed rail member 53, and a movable rail member 55 slidably supported by the intermediate rail member 54. The movable rail members 55 are fixed to the bottle mounting plate 45 of the bottle holder 5. The bottle holder 5 is configured to be horizontally movable between a stowed position (the position shown in FIG. 2) in which the water bottle 4 is stowed inside the housing 1, and a pulled out position (the position shown in FIG. 4) in which the water bottle 4 is moved out of the housing 1, by the relative sliding movements of the three rail members constituting each of the slide rails 49. The water outlet port 14 of the water bottle 4 faces the direction in which the bottle holder 5 is moved from the pulled out position toward the stowed position (the rearward direction in this embodiment).

The joint portion 6a is fixed in position inside the housing 1 such that the joint portion 6a is disconnected from the water outlet port 14 of the water bottle 4 when the bottle holder 5 has been moved to the pulled out position, as shown in FIG. 4, and the joint portion 6a is connected to the water outlet port 14 of the water bottle 4 when the bottle holder 5 has been moved to the stowed position, as shown in FIG. 2. When the water outlet port 14 of the water bottle 4 is connected to the joint portion 6a, the water bottle 4 is supported by the bottle holder 5 with the water outlet port 14 directed horizontally.

The front door 13 of the housing 1 is fixed to the bottle holder 5 so that the front door 13 slides together with the bottle holder 5. Thus, when the front door 13 is pulled forward to open the loading space 12, the bottle holder 5 is pulled out of the housing 1 at the same time. When the front door 13 is pushed rearward to close the loading space 12, the bottle holder 5 is stowed inside the housing 1 at the same time.

Wheels 56 are attached to the lower portion of the front door 13 so as to be kept in rolling contact with the surface on which the housing 1 is placed. When the bottle holder 5 is pulled out of the housing 1, and a load (such as the weight of a fully filled water bottle 4 and/or the weight of a person) acts on the bottle holder 5, the wheels 56 prevent the housing 1 from falling by supporting the load. Recesses 57 for stowing the wheels 56 are formed in the bottom plate 9 of the housing 1.

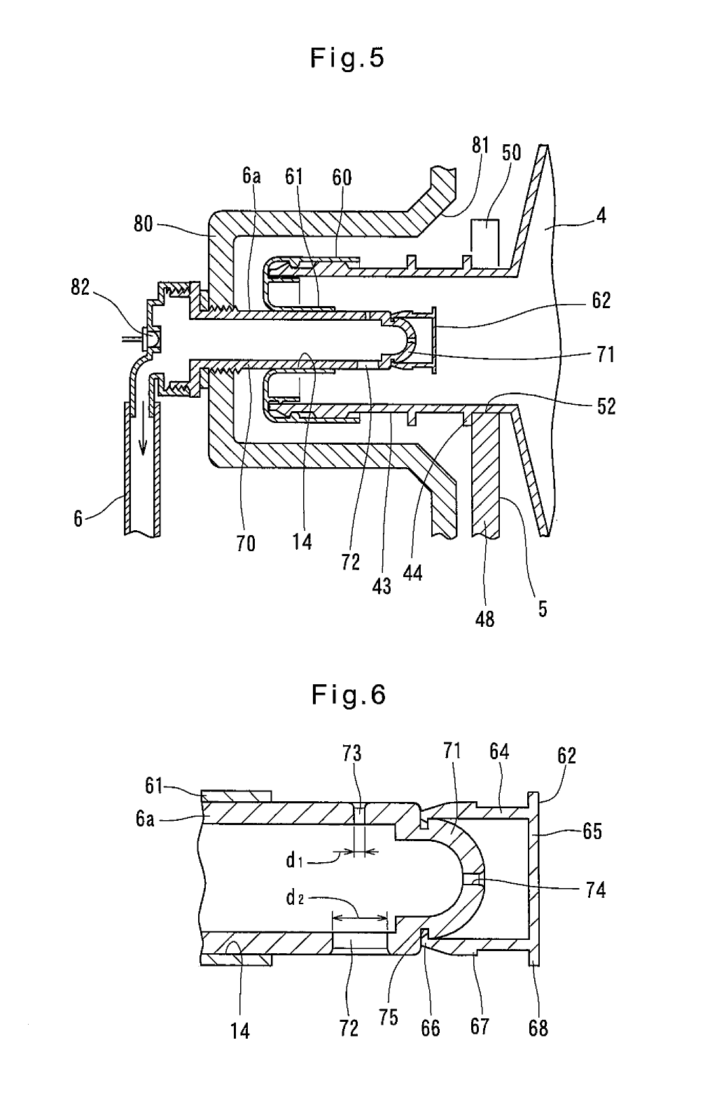

As shown in FIG. 5, a cap 60 is attached to the distal end of the neck portion 43 of the water bottle 4. An inner tube 61 is formed at the center of the cap 60. The inner tube 61 extends in parallel with the neck portion 43 toward the interior of the water bottle 4, and opens at its both ends. The interior region of the inner tube 61 defines the water outlet port 14 of the water bottle 4. A plug 62 is detachably fitted to the water outlet port 14. The cap 60 is formed by injection molding of a polyethylene (PE) resin.

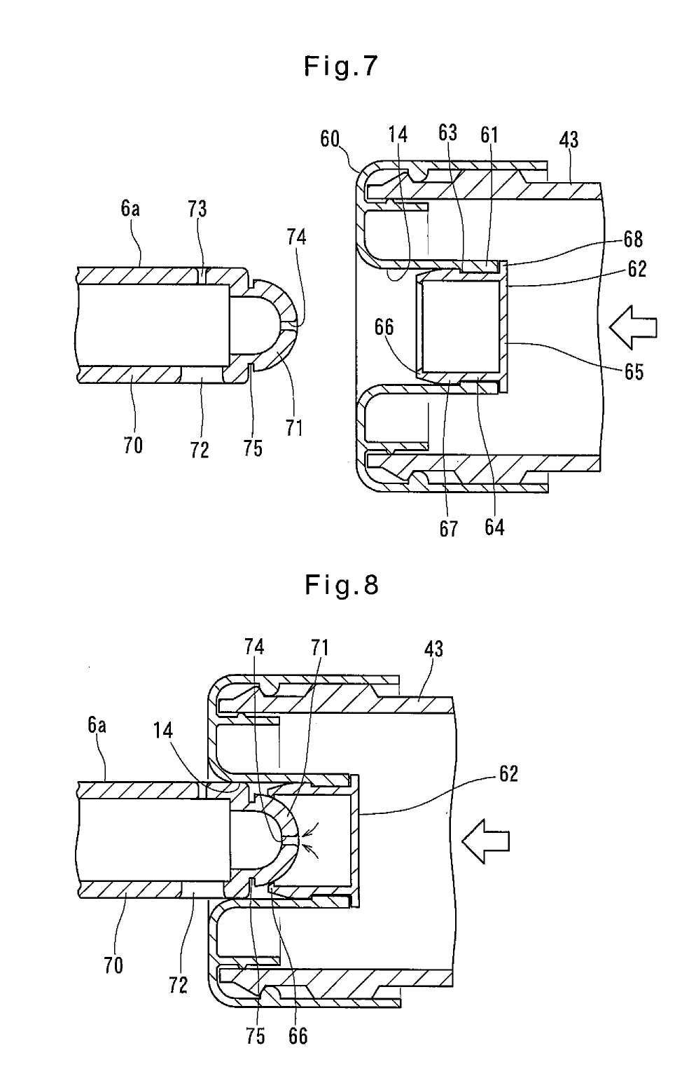

As shown in FIG. 7 and FIG. 8, the inner peripheral surface of the inner tube 61 is provided with a stepped portion 63 having a smaller diameter at its portion closer to the interior of the water bottle 4. The plug 62 is a cylindrical member including a cylindrical portion 64, a closed bottom end portion 65 provided at one end of the cylindrical portion 64, and a claw portion 66 provided along the inner periphery of the other end portion of the cylindrical portion 64. The plug 62 is fitted to the inner tube 61 with its opening facing the exterior of the water bottle 4. A projection 67 is formed on the outer peripheral surface of the cylindrical portion 64 so as to engage with the stepped portion 63 of the inner tube 61. An opposed piece 68 is provided at the end portion of the cylindrical portion 64 closer to the interior of the water bottle 4 so as to axially face the end portion of the inner tube 61.

The joint portion 6a comprises a cylindrical member extending in a horizontal direction and configured to be fitted to the water outlet port 14 of the water bottle 4. The joint portion 6a includes a straight portion 70 having a cylindrical outer peripheral surface, and a tip portion 71 formed in the shape of a hemisphere. The diameter of the straight portion 70 is determined such that the straight portion 70 can be fitted to the water outlet port 14 (that is, the inner tube 61) of the water bottle 4 with an interference fit. The straight portion 70 is provided with a water inlet hole 72 arranged such that drinking water W in the water bottle 4 can be introduced into the raw water pumping pipe 6 through the water inlet hole 72, when the joint portion 6a is connected to the water outlet port 14 of the water bottle 4. The water inlet hole 72 opens in a region of the lower half portion of the joint portion 6a (at the vertically lower end of the joint portion 6a in the figures).

An air inlet hole 73 is provided in a region of the joint portion 6a higher than the water inlet hole 72 (at the vertically upper end of the joint portion 6a in the figures). Through the air inlet hole 73, the interior and the exterior of the joint portion 6a communicate with each other. As shown in FIG. 11, the air inlet hole 73 is arranged such that air A in the water bottle 4 can be introduced into the drinking water W in the joint portion 6a through the air inlet hole 73, as air bubbles, when the water level in the water bottle 4 is higher than the position of the water inlet hole 72. The air inlet hole 73 has a sectional area smaller than that of the water inlet hole 72.

The air inlet hole 73 is provided so as to open at a position facing the water inlet hole 72. With this arrangement, air introduced into the joint portion 6a through the air inlet hole 73 can be sheared and efficiently turned into air bubbles, due to the flow of the drinking water flowing into the joint portion 6a through the water inlet hole 72. Alternatively, the air inlet hole 73 may be provided to open at a portion of the joint portion 6a downstream of the water inlet hole 72 (i.e. at its portion on the left-hand side, in the figures, of the position of the air inlet hole 73 shown in the figures). The latter arrangement also allows the air introduced into the joint portion 6a through the air inlet hole 73 to be sheared and efficiently turned into air bubbles, due to the flow of the drinking water flowing into the joint portion 6a through the water inlet hole 72.

The diameter d₁ of the air inlet hole 73 shown in FIG. 6 is 0.3 mm or more and 2.0 mm or less, and preferably, 0.5 mm or more and 1.5 mm or less. By setting the diameter d₁ of the air inlet hole 73 to 0.3 mm or more, preferably, to 0.5 mm or more, air A can be reliably introduced into the joint portion 6a through the air inlet hole 73, even with a pump 7 having a small discharge pressure. By setting the diameter d₁ of the air inlet hole 73 to 2.0 mm or less, preferably, to 1.5 mm or less, air A introduced into the joint portion 6a through the air inlet hole 73 can be reliably turned into air bubbles.

The diameter d₂ of the water inlet hole 72 is 3 mm or more and 10 mm or less, and preferably, 4 mm or more and 8 mm or less. By setting the diameter d₂ of the water inlet hole 72 to 3 mm or more, preferably, to 4 mm or more, it is possible to secure a sufficient flow rate of drinking water W flowing into the joint portion 6a, and thus, the air introduced into the joint portion 6a through the air inlet hole 73 can be reliably turned into air bubbles. By setting the diameter d₂ of the water inlet hole 72 to 10 mm or less, preferably, to 8 mm or less, the pressure inside the joint portion 6a can be maintained at a negative pressure due to the suction force of the pump 7, and the air A introduced into the joint portion 6a through the air inlet hole 73 can be reliably turned into air bubbles.

A through hole 74 is formed through the center of the tip portion 71 to communicate with the interior and the exterior of the joint portion 6a. The diameter of the through hole 74 is set to 1.0 mm or less. Further, a circumferential groove 75 is formed on the outer periphery of the joint portion 6a at the boundary between the straight portion 70 and the tip portion 71, and configured to be engaged with the claw portion 66 of the plug 62. As shown in FIG. 7 and FIG. 8, the through hole 74 allows air in the space defined between the plug 62 and the tip portion 71 to escape into the joint portion 6a, when the plug 62 is fitted to the tip portion 71 of the joint portion 6a, so that the plug 62 can be smoothly fitted to the tip portion 71 of the joint portion 6a.

As shown in FIG. 5, the joint portion 6a is fixed to a cup member 80 surrounding the joint portion 6a. The cup member 80 is a tubular member having a bottom portion and opens toward the water bottle 4, and the joint portion 6a extends through the bottom portion of the cup member 80 in a horizontal direction. A tapered surface 81 is formed at the opening edge of the cup member 80. The diameter of the tapered surface 81 increases toward the water bottle 4. The tapered surface 81 guides the neck portion 43 of the water bottle 4 toward the position of the joint portion 6a, if, as shown by the chain line in FIG. 4, the neck portion 43 of the water bottle 4 is not accurately aligned with the joint portion 6a when stowing the water bottle 4 into the housing 1.

As shown in FIG. 5, an ultraviolet light emitting device 82 is provided at the root of the joint portion 6a. The ultraviolet light emitting device 82 sterilizes drinking water W in the joint portion 6a, and the inner surface of the joint portion 6a, by irradiating ultraviolet light thereto. The ultraviolet light emitting device 82 may be an ultraviolet LED or a mercury lamp.

The joint portion 6a is made of a transparent material which allows ultraviolet light to transmit therethrough. Therefore, the ultraviolet light irradiated from the ultraviolet light emitting device 82 provided inside the joint portion 6a reaches the inner surface of the water outlet port 14 of the water bottle 4, and thus, the portion between the fitting surfaces of the water outlet port 14 and the joint portion 6a can also be sterilized. This prevents the drinking water in a new water bottle 4 from being contaminated with bacteria when replacing the empty water bottle 4 with the new bottle 4 (by disconnecting the joint portion 6a from the water outlet port 14 of the empty water bottle 4, and then connecting the joint portion 6a to the water outlet port 14 of the new water bottle 4).

As the raw water pumping pipe 6 (excluding the joint portion 6a), a silicone tube can be used. However, since silicone has an oxygen permeability, proliferation of bacteria is more likely to occur in such a raw water pumping pipe 6 due to the oxygen in the air that permeates through the silicone tube. Therefore, a metal pipe (such as a stainless steel pipe or a copper pipe) can be used as the raw water pumping pipe 6. With this arrangement, permeation of air through the wall of the raw water pumping pipe 6 can be prevented, thereby allowing for an effective prevention of the proliferation of bacteria in the raw water pumping pipe 6. In addition, heat resistance of the raw water pumping pipe 6 during the circulation of hot water can also be secured. The use of a polyethylene tube or a heat-resistant, rigid polyvinyl chloride tube as the raw water pumping pipe 6 also allows for preventing the permeation of air through the pipe wall of the raw water pumping pipe 6, thereby preventing the proliferation of bacteria in the raw water pumping pipe 6.

It is now described how the above mentioned water dispenser is used.

In the normal operation mode shown in FIG. 1, when a user of the water dispenser operates the cold water cock 28 to discharge low temperature drinking water in the cold water tank 2 into a cup or the like, the water level in the cold water tank 2 falls. When the user operates the hot water cock 39 to discharge high temperature drinking water in the hot water tank 3 into a cup or the like, too, the water level inside the cold water tank 2 falls because the same amount of drinking water as the discharged high temperature drinking water is introduced from the cold water tank 2 into the hot water tank 3 through the tank connecting passage 8. When the water level sensor 25 detects that the water level in the cold water tank 2 has fallen below a predetermined lower limit, the pump 7 is actuated and pumps out drinking water W from the water bottle 4 and supplies the drinking water W to the cold water tank 2 through the raw water pumping pipe. When the water level sensor 25 detects that the water level in the cold water tank 2 has reached a predetermined upper limit, the pump 7 is deactivated.

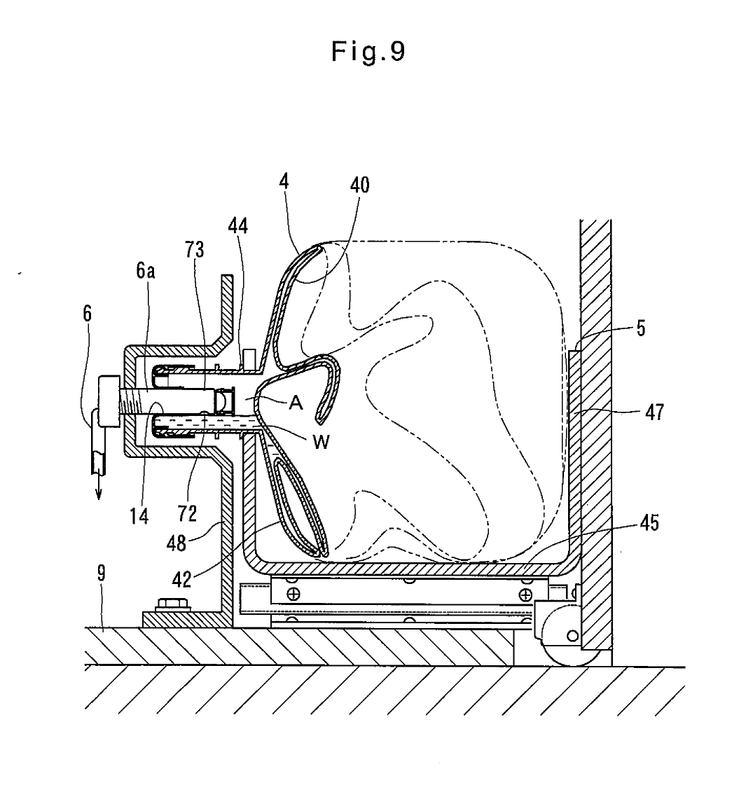

As the drinking water W in the water bottle 4 is pumped out by the pump 7, the water bottle 4 collapses due to atmospheric pressure, as shown in FIG. 9, and as the water bottle 4 collapses, the water level in the water bottle 4 gradually falls.

When the water level in the water bottle 4 falls to the position of the water inlet hole 72 of the raw water pumping pipe 6, air A in the water bottle 4 is introduced into the pump 7 through the raw water pumping pipe 6. This causes the pump 7 to idle and to lose its suction force, and it becomes difficult to pump out drinking water W in the water bottle 4 any further.

This state is detected by the flow rate sensor 16 because, in this state, drinking water W is not flowing in the raw water pumping pipe 6 in spite of the fact that the pump 7 is in operation, and the flow rate sensor 16 turns on a bottle-replacement lamp placed on the front surface of the housing 1, which is not shown, to notify a user that the water bottle 4 needs to be replaced.

In this water dispenser, it is possible to increase the extent to which the water bottle 4 collapses, by discharging air A in the water bottle 4 as air bubbles along with drinking water W while drinking water W in the water bottle 4 is being pumped out, thereby reducing the amount of drinking water remaining in the water bottle 4. This mechanism will be described in detail below.

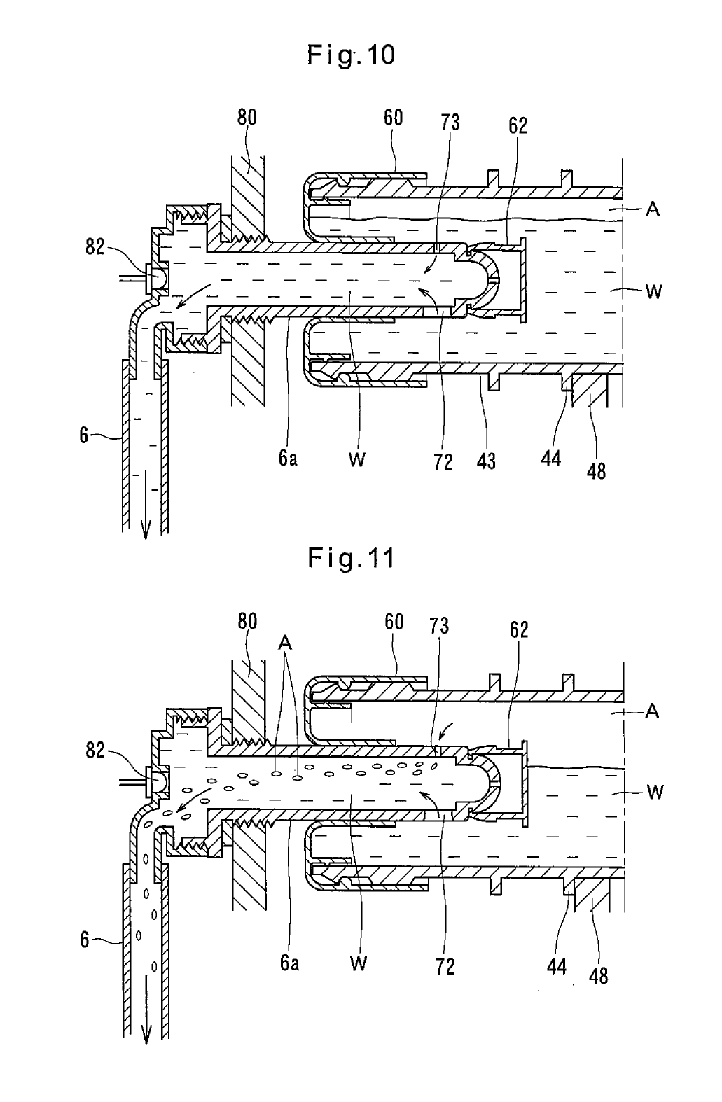

As shown in FIG. 10, when the water level in the water bottle 4 (that is, the boundary between the air A and the drinking water W) is higher than the position of the air inlet hole 73 provided in the joint portion 6a, drinking water W is introduced into the joint portion 6a through both the air inlet hole 73 and the water inlet hole 72, due to the suction force of the pump 7.

When, thereafter, the water level in the water bottle 4 has fallen to the position of the air inlet hole 73 provided in the joint portion 6a as shown in FIG. 11, and the pump 7 is actuated in this state, the pressure inside the joint portion 6a is maintained at a negative pressure due to the suction force of the pump 7. As a result, drinking water W in the water bottle 4 is introduced into the joint portion 6a through the water inlet hole 72, and at the same time, air A in the water bottle 4 is introduced into the drinking water W in the joint portion 6a through the air inlet hole 73, as air bubbles.

At this time, although air A introduced into the joint portion 6a enters the pump 7 through the raw water pumping pipe 6, it does not cause the pump 7 to lose its suction force because the air A is mixed into the drinking water W as air bubbles. The amount of the air A in the water bottle 4 is decreased, by the amount of the air A discharged from the water bottle 4 as air bubbles. This, as shown in FIG. 9, increases the extent to which the water bottle 4 collapses when the water level in the water bottle 4 falls to the position of the water inlet hole 72 thereby reducing the amount of drinking water remaining in the water bottle 4.

As described above, in this water dispenser, when the water level in the water bottle 4 has fallen to the position of the air inlet hole 73, and the drinking water W in the water bottle 4 is further pumped out by the pump 7 in this state, the air A in the water bottle 4 is discharged as air bubbles along with the drinking water W. This allows for increasing the extent to which the water bottle 4 collapses when the water level in the water bottle 4 falls to the position of the water inlet hole 72, thereby reducing the amount of drinking water remaining in the water bottle 4.

It is preferred that the air inlet hole 73 be formed to have a sectional area that is smaller than the sectional area of the water inlet hole 72. With this arrangement, air A introduced into the raw water pumping pipe 6 through the air inlet hole 73 can be turned into air bubbles, even if the pump 7 is capable of discharging only a small amount of water. This allows for using a pump 7 smaller in size, and contributes to the reduction in the cost.

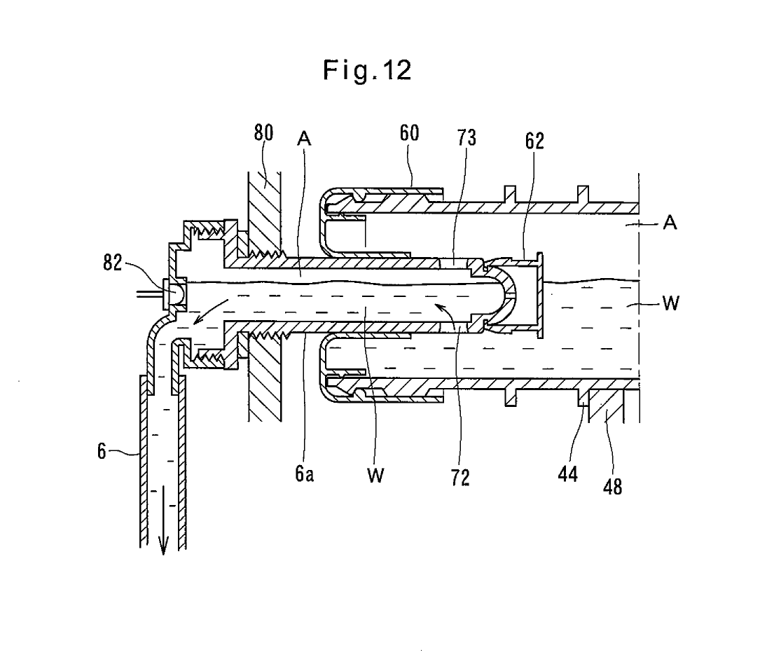

In cases where, as shown in FIG. 12, the air inlet hole 73 is formed to have a sectional area that is the same as, or larger than, the sectional area of the water inlet hole 72, if a pump 7 capable of discharging only a small amount of water is used, air A introduced into the joint portion 6a through the air inlet hole 73 is not turned into air bubbles. Therefore, when drinking water W in the water bottle 4 is pumped out by the pump 7, there is a potential risk that air in the water bottle 4 cannot be discharged. On the other hand, in cases where, as shown in FIG. 11, the air inlet hole 73 is formed to have a sectional area smaller than that of the water inlet hole 72, even if a pump 7 capable of discharging only a small amount of water is used, air A introduced into the raw water pumping pipe 6 through the air inlet hole 73 can be turned into air bubbles, and it is possible to stably discharge air A in the water bottle 4.

When the water level in the water bottle 4 falls to the position of the air inlet hole 73, in other words, when the water bottle 4 becomes empty, the user replaces the water bottle 4 as follows.

First, as shown in FIG. 4, the front door 13 is pulled forward to move the bottle holder 5 out of the housing 1. At this time, the water outlet port 14 of the water bottle 4 is disconnected from the joint portion 6a fixed inside the housing 1, since the water bottle 4 moves together with the bottle holder 5. Then the empty water bottle 4 is removed from the bottle holder 5. A fully filled water bottle 4 is then placed on the bottle holder 5 with the neck portion 43 of the water bottle 4 facing sideways such that the neck portion 43 of the water bottle 4 is fitted to the notch 50 of the bottle holder 5. Finally, the front door 13 is pushed back to stow the bottle holder 5 into the housing 1. At this time, since the water bottle 4 moves together with the bottle holder 5, the water outlet port 14 of the water bottle 4 is fitted to the joint portion 6a and connected thereto.

In the above mentioned water dispenser, it is possible to sterilize the raw water pumping pipe 6 and to secure the sanitation of the water dispenser for a long period of time, by performing sterilization operation regularly. The sterilization operation of the water dispenser will be described below.

First, as shown in FIG. 13, the first switching valve 17 is switched to allow communication between the first bypass pipe 18 and the pump 7, and the second switching valve 19 is switched to allow communication between the raw water pumping pipe 6 and the second bypass pipe 20. Then, the pump 7 is actuated. This allows high temperature drinking water in the hot water tank 3 to pass through the first bypass pipe 18, the first switching valve 17, the raw water pumping pipe 6, the second switching valve 19, and the second bypass pipe 20, sequentially, and to return to the hot water tank 3. In other words, high temperature drinking water in the hot water tank 3 circulates through the raw water pumping pipe 6. By energizing the heating device 37 of the hot water tank 3 at this time, it is possible to maintain the temperature of the circulating drinking water at a high temperature suitable for sterilization. Thus, the drinking water inside the raw water pumping pipe 6, the inner surface of the raw water pumping pipe 6, and the interior of the pump 7 can be sterilized by heat.

After the completion of the sterilization operation, the pump 7 is stopped, and, as shown in FIG. 1, the first switching valve 17 is switched to allow communication between the joint portion 6a and the pump 7, and the second switching valve 19 is switched to allow communication between the raw water pumping pipe 6 and the cold water tank 2, to return to the normal operation mode.

By regularly performing the sterilization operation as described above, it is possible to sterilize the raw water pumping pipe 6, through which normal temperature drinking water flows during the normal operation mode, and to secure the sanitation of the water dispenser for a long period of time.

Further, in the present water dispenser, the water bottle 4 is disconnected from the end portion of the raw water pumping pipe 6 when the bottle holder 5 is pulled out of the housing 1, and the water bottle 4 is connected to the end portion of the raw water pumping pipe 6 when the bottle holder 5 is stowed inside the housing 1. In other words, it is not necessary to configure the raw water pumping pipe 6 so as to follow the movement of the bottle holder 5. As a result, the length of the raw water pumping pipe 6 can be made short, thereby preventing the proliferation of bacteria in the raw water pumping pipe 6.

Since, in the above mentioned water dispenser, the raw water pumping pipe 6 is not required to follow the movement of the bottle holder 5, it is not necessary to use a spiral tube or a flexible tube for the raw water pumping pipe 6, and a rigid one can be used as the raw water pumping pipe 6. Thus, a metal pipe (such as a stainless steel pipe and a copper pipe) excellent in oxygen barrier properties and heat resistance can be used as the raw water pumping pipe 6.

In the above mentioned water dispenser, since the movement of the water outlet port 14 of the water bottle 4 is restricted by the restricting portion 52 of the bottle holder 5, when the water outlet port 14 of the water bottle 4 is connected to the joint portion 6a, it is possible to prevent the situation where the water outlet port 14 is displaced from the position of the joint portion 6a due to the deformation of the water bottle 4, which is formed flexible, and the joint portion 6a can be connected to the water outlet port 14 smoothly and stably.

Further, in the above mentioned water dispenser, since the raw water pumping pipe 6 is provided such that it passes through a position lower than the joint portion 6a, and the pump 7 is disposed in the raw water pumping pipe 6 at its portion lower than the joint portion 6a, when the water outlet port 14 of the water bottle 4 is disconnected from the joint portion 6a, it is possible to prevent drinking water W remaining in the raw water pumping pipe 6 from flowing out of the joint portion 6a due to its own weight.

If the bottle holder 5 is configured to be moved into and out of the housing 1 in the forward and rearward direction as in the above mentioned embodiment, the installation space of the water dispenser can be reduced. However, it is also possible to configure the bottle holder 5 so as to be movable into and out of the housing 1 in the right and left direction.

In the above described embodiment, an example of the water dispenser is described in which the water bottle 4 is set to the water dispenser with the water outlet port 14 of the water bottle 4 directed horizontally, and the joint portion 6a extending horizontally is configured to be connected to the water outlet port 14. However, the present invention is also applicable to a water dispenser in which the water bottle 4 is set therein with the water outlet port 14 of the water bottle 4 facing obliquely upward, and to a water dispenser in which, the water bottle 4 is set therein with the water outlet port 14 of the water bottle 4 facing obliquely downward.

### DESCRIPTION OF SYMBOLS

4 water bottle
6 raw water pumping pipe
7 pump
72 water inlet hole
73 air inlet hole
W drinking water

1. A water dispenser comprising: a raw water pumping pipe configured to be connected to a replaceable water bottle formed flexible so as to be collapsible as an amount of water remaining in the water bottle decreases; and a pump for pumping out drinking water from the water bottle through the raw water pumping pipe;
wherein the raw water pumping pipe includes:
a water inlet hole arranged such that with the raw water pumping pipe connected to the water bottle, drinking water in the water bottle can be introduced into the raw water pumping pipe through the water inlet hole; and
an air inlet hole arranged such that air in the water bottle can be introduced into the drinking water in the raw water pumping pipe through the air inlet hole, as air bubbles, when a water level in the water bottle is higher than a position of the water inlet hole.

2. The water dispenser according to claim 1, wherein the air inlet has a sectional area that is smaller than a sectional area of the water inlet hole.
